(19) United States
(12) Patent Application Publication
(10) Pub. No.: US 2021/0287643 A1
(43) Pub. Date: Sep. 16, 2021

(54) METHOD AND APPARATUS FOR CONVERTING COLOR DATA INTO MUSICAL NOTES

(71) Applicant: Zi Hao QIU, Metuchen, NJ (US)

(72) Inventor: Zi Hao QIU, Metuchen, NJ (US)

(21) Appl. No.: 16/619,405

(22) PCT Filed: May 27, 2016
(86) PCT No.: PCT/US16/34769

§ 371 Date: Dec. 4, 2019

(51) Int. Cl. G10H 1/00; G06T 7/90; G06T 11/00; G10G 3/04; B43K 29/00

(52) U.S. Cl. CPC G10H 1/0025; G06T 7/90; G06T 11/001; G10G 3/04; G10H 2220/451; G06T 2207/10008; G06T 2207/10024; G10H 2210/145; G10H 2210/111; B43K 29/005

(57) ABSTRACT

An approach is provided for converting color data into one or more musical notes. The approach involves reading, using a color-reading device, respective colors applied to a canvas by a plurality of drawing instruments as color data, wherein each of the plurality of drawing instruments is configured to draw in respective colors of a color palette, and wherein the respective colors of the color palette correspond respectively to a set of musical notes. The approach also involves processing, using a color processing module, the color data to generate a composition of the one or more musical notes from the color data based on a set of musical notes that correspond to the respective colors in the color data.

### BACKGROUND

Users enjoy composing music as well as listening to music. However, the difficulty in understanding and recognizing the overwhelming number of musical concepts makes it tough for users with limited music experience to compose music. Correspondingly, providing musical instruction to individuals with no music experience can be very difficult, and this difficulty is intensified when the musical instruction is directed to children. One big challenge for service providers is to offer an effective and efficient approach for identifying one or more musical notes, for instance, by colors that can be correlated individually with each of the musical notes. Then, converting these colors into one or more musical notes.

### SOME EXAMPLE EMBODIMENTS

Therefore, there is a need for an approach for converting color data into one or more musical notes.

According to one embodiment, a system comprises a plurality of drawing instruments, wherein each of the plurality of drawing instruments is configured to draw in respective colors of a color palette. The respective colors of the color palette correspond respectively to a set of musical notes. The system also comprises a canvas configured for the plurality of drawing instruments to apply the respective colors of the color palette. The system further comprises a color-reading device configured to read the respective colors applied to the canvas by the plurality of drawing instruments as color data. The system further comprises a color processing module configured to process the color data to generate a composition of the one or more musical notes from the color data based on the set of musical notes that correspond to the respective colors in the color data.

According to one embodiment, a method comprises reading, using a color-reading device, respective colors applied to a canvas by a plurality of drawing instruments as color data, wherein each of the plurality of drawing instruments is configured to draw in respective colors of a color palette, and wherein the respective colors of the color palette correspond respectively to a set of musical notes. The method also comprises processing, using a color processing module, the color data to generate a composition of the one or more musical notes from the color data based on a set of musical notes that correspond to the respective colors in the color data.

According to another embodiment, an apparatus comprises at least one processor, and at least one memory including computer program code for one or more computer programs, the at least one memory and the computer program code configured to, with the at least one processor, cause, at least in part, the apparatus to read, using a color-reading device, respective colors applied to a canvas by a plurality of drawing instruments as color data, wherein each of the plurality of drawing instruments is configured to draw in respective colors of a color palette, and wherein the respective colors of the color palette correspond respectively to a set of musical notes. The apparatus is also caused to process, using a color processing module, the color data to generate a composition of the one or more musical notes from the color data based on a set of musical notes that correspond to the respective colors in the color data.

According to another embodiment, a computer-readable storage medium carries one or more sequences of one or more instructions which, when executed by one or more processors, cause, at least in part, an apparatus to read, using a color-reading device, respective colors applied to a canvas by a plurality of drawing instruments as color data, wherein each of the plurality of drawing instruments is configured to draw in respective colors of a color palette, and wherein the respective colors of the color palette correspond respectively to a set of musical notes. The apparatus is also caused to process, using a color processing module, the color data to generate a composition of the one or more musical notes from the color data based on a set of musical notes that correspond to the respective colors in the color data.

According to another embodiment, an apparatus comprises means for reading, using a color-reading device, respective colors applied to a canvas by a plurality of drawing instruments as color data, wherein each of the plurality of drawing instruments is configured to draw in respective colors of a color palette, and wherein the respective colors of the color palette correspond respectively to a set of musical notes. The apparatus also comprises means for processing, using a color processing module, the color data to generate a composition of the one or more musical notes from the color data based on a set of musical notes that correspond to the respective colors in the color data.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 11-20 and 32-35.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of converting color data into one or more musical notes, according to one example embodiment;

FIG. 2 is a diagram of the components of the image processing platform 103, according to one example embodiment;

FIG. 3 is a flowchart of a process for converting color data into one or more musical notes, according to one example embodiment;

FIG. 4 is a flowchart of a process for causing a playback of the composition of the one or more musical notes, according to one example embodiment;

FIG. 5 is a flowchart of a process for determining note duration information for the one or more musical notes, according to one example embodiment;

FIG. 6 is a diagram of a plano keyboard used in the various processes described herein;

FIG. 7A is a diagram utilized in the processes of FIG. 3-5, according to one example embodiment;

FIG. 7B is a diagram that represents the colors applied on a canvas in a different format, according to one example embodiment;

FIG. 8 is a user interface diagram utilized in the processes of FIG. 3-5, according to one example embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for converting color data into one or more musical notes (and vice versa) are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

The various embodiments of this method, apparatus, and computer program relate to an image conversion technique for turning drawings into musical notes. In other embodiment, this method could be equally applied to transform musical notes into visual representations (e.g., displaying color bars and scales on a canvas). By way of example, these embodiments can be applied to the industries of communications, video, composing, teaching, games and other computer-related fields.

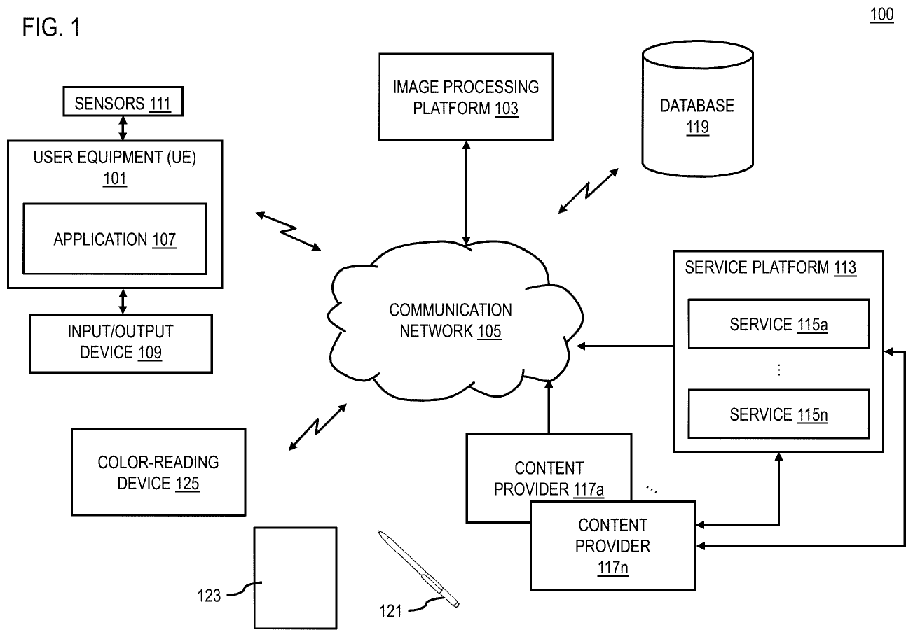

FIG. 1 is a diagram of a system capable of converting color data into one or more musical notes, according to one embodiment. As noted above, composing music requires expertise in musical skills to achieve good results. An average user may experience difficulty in understanding written music due to the counter-intuitive nature of traditional music notation. In addition, young users may have difficulty in understanding written music due to the complex nature of the musical structures. As a result, system 100 associates one or more visual representation (e.g., colors) with one or more musical notes. These colors are associated according to a predefined color scheme based on the tonal or rhythmic qualities of the musical notes. This allows inexperienced users as well as young users to compose music by using colors, while intuitively becoming aware of musical structures. Subsequently, the colors are converted into musical notes. This process of converting color data to musical notes traditionally has relied on expertise in cross-disciplinary artistic concepts (e.g., music theory, composition, etc.) combined with artistic and musical skill to achieve subjectively pleasing or “good” results. However, this knowledge and skill often is out of reach for average users, thereby, limiting the ability of these users to convert color data to musical notes.

In light of this problem, in one embodiment, a system 100 of FIG. 1 introduces a system comprising a set of drawing instruments 121 (e.g., physical drawing tools such as pens, paints, etc., as well as virtual drawing tools provided in computer applications or software) that is calibrated to produce color on a canvas 123 (e.g., physical or virtual canvas) that can then be read or scanned by a color-reading device 125. In one embodiment, each of the drawing instruments 121 is configured to apply or produce a color on the canvas 123 that corresponds to a particular musical note. For example, a manufacturer of the drawing instrument 121 can predetermine a color palette in which each specific color (e.g., each color being defined according to any color system such as Pantone) is matched to a specific note. Accordingly, in one embodiment, each instrument 121 (e.g., a colored pen) corresponds to a defined musical note, so that when a user uses an instrument 121 of a particular color, the user is effectively encoding a corresponding musical note onto the canvas 123. As noted above, for users who are not familiar or skilled in writing a musical composition using standard musical notation (e.g., staff notation), the user can more intuitively and advantageously draw or apply colors in an arrangement by using the color-calibrated instruments 121 to create a visual representation of a composition that can then be converted by the system 100 into a musical composition or set of musical notes.

In one embodiment, the color-reading device produces color data indicating the colors applied on the canvas 123 by using, for instance, an optical scanner or equivalent technology to measure the color wavelength or other indicator of the color applied to the canvas 123. In one embodiment, the instruments 121 can be calibrated to produce a specific or consistent color on the canvas 123 to improve an accuracy of the color reading. Depending on the color and/or material (e.g., canvas, linen, paper, etc.) of the canvas 123 itself, the color applied to that canvas 113 can be different than the color of the instrument 121 itself. For example, in one case, applying a green color to canvas 123 that is shaded yellow may result in a more blue tone for the applied color as it appears on the canvas 123. In one embodiment, color accuracy and the ability to accurately differentiate between a large number of colors is particularly important when trying to map those colors to the full range of musical notes available to, for instance, a full 88-note keyboard. In the case of a full 88-note keyboard, the system 100 would use at least eighty-eight colors and corresponding instruments 121 to represent each of the eighty-eight notes. With such a large palette, there may be just subtle variations or differences between the colors of any two instruments 121 calibrated to the palette. Therefore, potential differences in shading caused by differences in appearance of the color of the instruments 121 when actually applied to the canvas 123 can potentially be significant.

To address this technical problem, in one embodiment, the system 100 calibrates the mapping between musical notes and color based on the resulting color as applied by the instrument 121 to the canvas 123. In other words, in one embodiment, the system 100 provides a set of drawing instruments 121 is that matched and color-calibrated to a specific type of canvas 123 to produce a known consistent color. In other embodiments, the system 100 can maintain different color mappings between color and musical notes for each combination of the drawing instruments 121 and canvases 123 of different colors or materials. In yet another embodiment, the color reading device 125 can dynamically color correct its reading by adjusting or balancing the color temperature based on the color or material of the canvas 123 before matching against a musical notes corresponding to a color palette. In this way, the image processing platform 103 can process the color data to match each detected color in the color data to a corresponding musical note with consistency and accuracy even in cases where the number of possible colors and notes is high and the differences between the colors can be small. In one embodiment, the sequence of musical notes in the color data then is generated to create a musical composition or song that represents the colors applied to the canvas 123 by the instruments 121.

In one embodiment, the color-reading device 125 can also scan or read other characteristics of the colors as applied on the canvas 123. For example, the color-reading device 125 can perform a complete optical scan of the canvas 123 to create a digital representation of the canvas 123, thereby making the digital representation effectively the color data discussed above. With this digital representation, the image processing platform 103 can use image recognition and object detection algorithms to process the color data to identify shapes, sizes of those shapes, or other features (e.g., lines, symbols, etc.) drawn using the instruments 121. In this way, the image processing platform 103 has the capability to convert color data into one or more musical notes, for instance, by determining one or more features (e.g., color, shape, size, etc.) from the color data; obtaining a set of musical notes based on the relationships mapped for these features, the set including a range of musical notes, tones; and then generating a musical composition from the derived notes.

In one embodiment, the image processing platform 103 can then output the musical composition in any format or media selected by a user. For example, the composition can then be played through an audio out as audible music. In another embodiment, the composition can be converted into another musical notation system (e.g., staff notation or any other system of musical notation). In one embodiment, the image processing platform 103 uses an algorithmic process based on certain parameters (e.g., color level, shapes and/or sizes of the color appearing on the canvas 123, associated symbols/drawings/patterns, etc.) By way of example, the image processing platform 103 can use these parameters in the algorithm to determine one or more musical characteristics for generating the composition including, but not limited to, the sound level, pitch, or duration for the one or more musical notes.

As shown in FIG. 1, the system 100 comprises user equipment (UE) 101 that may include or be associated with applications 107 and sensors 111. In one embodiment, the UE 101 has connectivity to an image processing platform 103 via a communication network 105, e.g., a wireless communication network. In one embodiment, the image processing platform 103 performs one or more functions associated with converting color data into one or more musical notes.

In one embodiment, the conversion from color data to musical notes using this method includes first receiving a canvas 123 on which a user has applied a visual arrangement of colors from the drawing instruments 121 (e.g., colored pens) calibrated to a set of colors which have been mapped to correspond to particular musical notes. As noted above, a service provider or manufacturer can predetermine which colors correspond to which musical notes. In such a case, each drawing instrument 121 that is configured to produce a particular color can be marked to indicate a corresponding music note. For example, if red corresponds to middle C, a red drawing instrument 121 (e.g., red colored pen) is calibrated to draw that particular red color on the canvas 123, then the tool can be marked with middle C.

In yet another embodiment, the system 100 can enable the end user or other user to dynamically vary the mapping of the colors of the instruments 121 and the corresponding musical note. In this case, the image processing platform 103 can present a user interface in which the user can manually specific which of the colors of the instruments 121 correspond to which musical notes. In one embodiment, the manual correlation can occur on a color by color basis. In addition or alternatively, the image processing platform 103 can shift colors along a musical scale based on change in a single note or color combination. For example, if red is matched to middle C by default, and the user changes the mapping so that green now is matched to middle C, the image processing platform 103 can use the same initial color sequence but shift all other default colors in the same sequence so that green matches or corresponds to middle C on a musical scale.

As shown in FIG. 1, the system 100 comprises of UE 101. In one embodiment, the UE 101 is any type of mobile terminal, fixed terminal, or portable terminal including a navigation unit (e.g., in-vehicle or standalone), a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the image processing platform 103 may be a platform with multiple interconnected components. The image processing platform 103 may include one or more servers, intelligent networking devices, computing devices, components and corresponding software for converting color data into one or more musical notes (and vice versa). In addition, it is noted that the image processing platform 103 may be a separate entity of the system 100, a part of the one or more services 115a-115n (collectively referred to as services 115) of the services platform 113, or the UE 101. Any known or still developing methods, techniques or processes for converting color data into one or more musical notes may be employed by the image processing platform 103.

In one embodiment, the image processing platform 103 may read respective colors applied to a canvas by a plurality of drawing instruments as color data using a color-reading device. Then, the image processing platform 103 may process the color data to generate a composition of the one or more musical notes from the color data based on the set of musical notes that correspond to the respective colors in the color data. In other words, in one embodiment, the image processing platform 103 may convert color data into one or more musical notes by the following means: 1) determining one or more features (e.g., colors, color patterns, and color sizes) from the color data; (2) corresponding or mapping these features to one or more musical notes stored in the database 119; and (3) generating a visual representation or an aural representation of the one or more musical notes that correspond to the respective colors in the color data. In another embodiment, the image processing platform 103 may read an application a respective color applied to a canvas by a plurality of drawing instruments as color data. Then, the image processing platform 103 may process the color data to generate a composition of the one or more musical notes from the color data based on the set of musical notes that correspond to the respective colors in the color data. In one embodiment, each of the plurality of drawing instruments is configured to draw in respective colors of a color palette.

In one embodiment, the image processing platform 103 may generate a legend for correlating the one or more colors, their patterns and sizes to the one or more musical notes. In one example embodiment, the image processing platform 103 may use the features extracted from the color data to match the musical notes to its appropriate partner. In another embodiment, the image processing platform 103 may process one or more color data to determine one or more element (e.g., shades, ranges, hues, brightness, contrasts, purity) of the color data. These elements can be used to determine tone or frequency of the one or more musical notes. For example, the drawings on a canvas may contain different colors. The one or more musical notes can have a color value assigned to them. The image processing platform 103 may express the musical notes, volume and pitch depending on the color data and their sizes.

In a further embodiment, the image processing platform 103 may determine the size of the one or more colors, wherein the size of the colors can be used to represent the duration of the musical notes.

In one embodiment, the image processing platform 103 enables musical notes to be derived from drawings, allowing users to compose the well-known tunes by drawing certain the colors sequence. In one embodiment, the image processing platform 103 may create values for each color that corresponds to a musical note. When initially setting default values without any initial color input, a color continuum can be chosen and values assigned to each shade, to be assigned to the musical notes at a later stage. In this way, a knowledge of music are not essential for appreciating the links between music and art, and one can enhance the interaction between music and art by using colors on a canvas that establishes a mapping between color values and musical notes, as well as a mapping between durations for musical notes and the size of the colors.

Further, various elements of the system 100 may communicate with each other through a communication network 105. The communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular communication network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), vehicle controller area network (CAN bus), and the like, or any combination thereof.

The UE 101 may further include applications 107 to perform one or more functions of converting color data into one or more musical notes. In one embodiment, the applications 107 and the image processing platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

In one embodiment, the UE 101 further has connectivity to one or more input/output devices 109 for ingesting image data or for generating musical notes. In one embodiment, the input/output devices 109 include a color-reading device. For example, for ingesting image data, the input/output device 109 may include a camera or a scanner for capturing image data. It is contemplated that the input/output device may be configured with any sensor suitable for sampling or capturing visual data into digital format for processing by the system 100. In one embodiment, for outputting musical notes in an aural or visual representation, the input/output device 109 can be configured with any number of suitable output modules. For example, the input/output device 109 may be configured with displays (e.g., monitors, projectors, televisions, etc.) for aural or visual representation of the one or more musical notes. In addition, the input/output device 109 may include devices for creating physical versions (e.g., paper, canvas, and/or other media such as wood, stone, etc.) of the one or more musical notes converted from the color data. These devices include, but are not limited to, printers, three-dimensional printers, computerized numerical control (CNC) machines, printing presses, and the like.

The system 100 also includes one or more sensors 111, which can be implemented, embedded or connected to the UE 101. It is contemplated that the UE 101 may be configured with any sensors suitable for sampling or capturing an image data into digital format for processing by the system 100. The sensors 111 may be any type of sensor. In one embodiment, the type of sensors 111 configured can be based on the type of source data. For example, it is contemplated that image data can include color data presented in any form. If image data is presented in the form of drawings, for instance, the UE 101 can use a camera/imaging sensor (e.g., scanning device or a camera) to capture the drawings for conversion into one or more musical notes and their respective durations. The system 100 can then process the drawings to extract the color data through image recognition techniques. In one example embodiment, a color-reading device is configured with sensors 111 capable of reading color values. In this way, a user can create musical notes by using the color-reading device to read different colors (e.g., from a drawing, an existing image, painting, or other visual representation). The colors that are read by the color-reading device are then converted into musical notes using the processes discussed with respect to the various embodiments described herein.

In one embodiment, the UE 101 and/or the image processing platform 103 also have connectivity to a service platform 113 that includes one or more services 115 for providing other services that support the image processing platform 103. By way of example, the services platform 113 may include social networking services/application, content (e.g., audio, video, images, etc.) provisioning services/application, application services/application, storage services/application, etc. In one embodiment, the services platform 113 may interact with the UE 101, the image processing platform 103 and the content provider 117 to supplement or aid in the processing of the content information. In one embodiment, the services platform 113 may be implemented or embedded in the image processing platform 103 or in its functions.

By way of example, the services 115 may be an online service that reflects interests and/or activities of one or more users. The services 115 allow users to share activities information, historical user information and interests (e.g., musical interest) within their individual networks, and provides for data portability. In one embodiment, the service platform 113 and/or services 115 interact with one or more content providers 117a-117n (also collectively referred to as content providers 117) to provide musical notes and/or other related information to the image processing platform 103. The content provided may be any type of content, such as, image content, textual content, audio content (e.g., audio notification), video content (e.g., visual notification), etc. In one embodiment, the content provider 117 may also store content associated with the UE 101, the image processing platform 103, and the services 115 of the services platform 113.

The system 100 also includes database 119. The database 119 stores one or more musical notes corresponding to one or more colors. The information may be any multiple types of information that can provide means for aiding in the content provisioning and sharing process.

The system 100 also includes a plurality of drawing instruments (e.g., color pen 121) that are calibrated to draw the respective colors of the color palette on a canvas 123. In one example embodiment, each color pen exudes ink or other artistic material (e.g., paint, charcoal, etc.) that corresponds to the color wavelength of a predefined color. The color of the ink or other material contained by the color pen or other instrument 121 falls within the wavelength of a color data to be assigned with a specific musical note.

In one embodiment, the drawing instruments 121 can be virtual drawing instrument that is provided in a computer application (e.g., a drawing or painting application). In this example the palette selected in the computer application (e.g., executable on a mobile device, tablet, desktop PC, standalone system, etc.) can be calibrated to a set of musical notes in the same process as described above. For example, a custom palette can be created for use in a particular drawing application. In one embodiment, the palette can be imported into third party drawing applications via public application programming interfaces (APIs) or other similar interfaces.

The system 100 also includes canvas 123. In one embodiment, the canvas 123 is configured for the plurality of drawing instruments to apply the respective colors of the color palette. In another embodiment, similar to the virtual instruments 121 described above, the canvas 123 can a virtual canvas in a computer application (e.g., the same computer application supporting the virtual drawing instruments 121 described above). As with a physical canvas 123, the virtual canvas 123 can also be simulated to be of different colors and/or materials. In this case, the color mapping between the color palette and musical notes can also account for the colors as they would appear on the virtual canvas 123.

The system 100 also includes color-reading device 125. In one embodiment, the color-reading device 125 may read respective colors applied to a canvas via an image sensor, a scanner, or a combination thereof. In another embodiment, the color-reading device 125 may scan a shape or a size of the respective colors applied to the canvas as part of the color data. In a further embodiment wherein the system 100 is implemented as a computer application rather than physical components, the color-reading device 125 may a color-reading module of the computer application that supports or provides the virtual drawing instruments 121 and virtual canvas 123.

By way of example, the UE 101, the image processing platform 103, and the conversion application 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

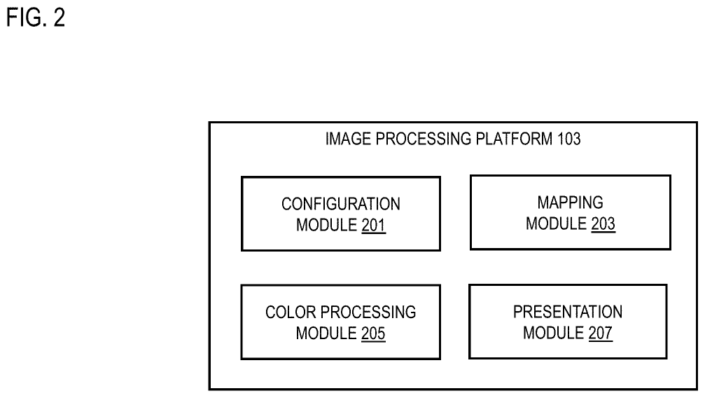

FIG. 2 is a diagram of the components of the image processing platform 103, according to one example embodiment. By way of example, the image processing platform 103 includes one or more components for converting color data into one or more musical notes. It is contemplated that the functions of these components may be combined in one or more components or performed by other components of equivalent functionality. In one embodiment, the image processing platform 103 comprises one or more configuration modules 201, mapping modules 203, color processing modules 205, and presentation modules 207, or any combination thereof.

In one embodiment, the configuration module 201 may configure a color-reading device to scan respective colors of a color palette drawn on a canvas by plurality of drawing instruments. In another embodiment, the configuration module 201 may configure an application of a mobile device to read respective colors of a color palette drawn on a canvas of the application by plurality of virtual drawing instruments. In one example embodiment, the color-reading device and/or the application of a mobile device includes an image sensor, a scanner, or a combination thereof to read respective colors. In another embodiment, the configuration module 201 may configure color pens to draw the respective colors of the color palette on a canvas. In one example embodiment, each color pen exudes ink that has the same color frequency as that of a predefined color. The ink secreted by the color pen on a canvas falls within the wavelength or the frequency of a color data to be assigned with a specific musical note. In a further embodiment, the configuration module 201 may configure the color processing module 205, as discussed herein below.

In one embodiment, the mapping module 203 may associate at least one color with at least one musical note. In another embodiment, the mapping module 203 may associate at least one color pattern with at least one set of musical note. In a further embodiment, the mapping module 203 may correlate the size of the color drawn on the canvas, the canvas of an application, or a combination thereof to the duration for the one or more musical notes.

In one embodiment, the color processing module 205 may process the color data to generate a composition of the one or more musical notes from the color data based on the set of musical notes that correspond to the respective colors in the color data. In one example embodiment, the color processing module 205 may generate a composition of musical notes that correspond to the respective colors based, at least in part, on the sequence of colors applied to a canvas, a canvas of an application, or a combination thereof. In another embodiment, the color processing module 205 may be configured to determine note duration information for the one or more musical notes in the composition based on the shape or the size of the respective colors. In one example embodiment, the color processing module 205 may generate a composition based, at least in part, on the duration information for the one or more musical notes. In a further embodiment, the color processing module 205 is configured to generate a representation of the composition in staff notation and to output the composition in the staff notation via an output device. In another example embodiment, the color processing module 205 may process a drawing to determine a sequence for one or more colors. Then, the color processing module 205 may select one or more musical notes that correlate to the one or more colors based, at least in part, on the sequence. Subsequently, the color processing module 205 may convert the one or more colors with the one or more musical notes.

In one embodiment, the presentation module 207 may representation of the composition in staff notation in at least one user interface of at least one device. In one embodiment, the representation includes a visual representation, an aural representation, or a combination thereof. In another embodiment, the presentation module may provide guidance information to the one or more users, for example, one or more users may be informed regarding a particular color to be drawn on a canvas for a specific musical note. In a further embodiment, the presentation module 207 employs various application programming interfaces (APIs) or other function calls corresponding to the applications 107 of UE 101 and/or input/output device 109, thus enabling the display of graphics primitives such as menus, buttons, data entry fields, etc., for generating the user interface elements. In one embodiment, the presentation module 207 enables a presentation of a graphical user interface (GUI) for displaying one or more colors to the users for drawing on a canvas of an application.

The above presented modules and components of the image processing platform 103 can be implemented in hardware, firmware, software, or a combination thereof. Though depicted as a separate entity in FIG. 1, it is contemplated that the image processing platform 103 may be implemented for direct operation by respective UE 101. As such, the image processing platform 103 may generate direct signal inputs by way of the operating system of the UE 101 for interacting with the applications 107. In another embodiment, one or more of the modules 201-207 may be implemented for operation by respective UEs, as the image processing platform 103, or combination thereof. Still further, the image processing platform 103 may be integrated for direct operation with the services 115, such as in the form of a widget or applet, in accordance with an information and/or subscriber sharing arrangement. The various executions presented herein contemplate any and all arrangements and models.

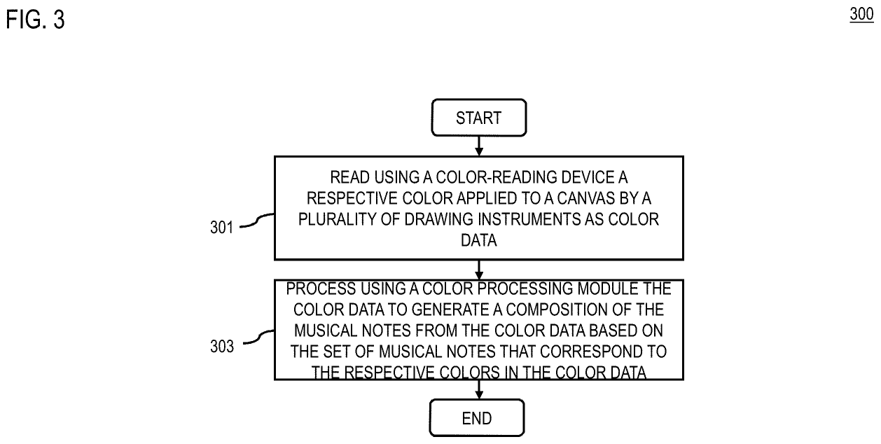

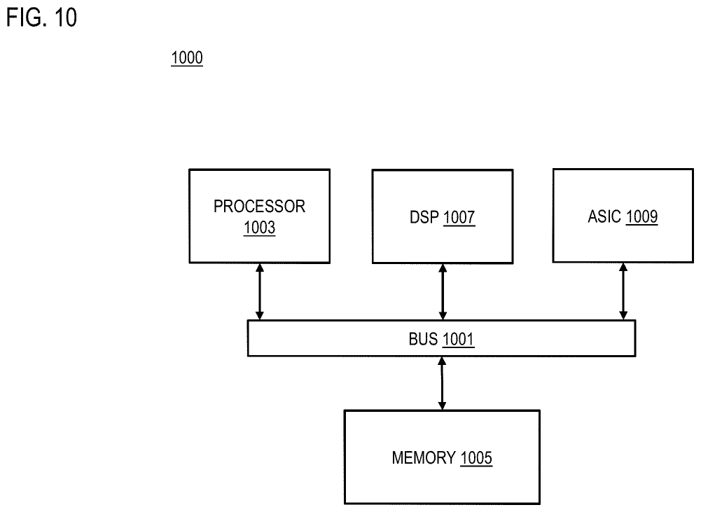

FIG. 3 is a flowchart of a process for converting color data into one or more musical notes, according to one example embodiment. In one embodiment, the image processing platform 103 performs the process 300 and is implemented in, for instance, a chip set including a processor and a memory as shown in FIG. 10.

In step 301, the image processing platform 103 may read using a color-reading device a respective color applied to a canvas by a plurality of drawing instruments as color data. In one embodiment, each of the plurality of drawing instruments is configured to draw in respective colors of a color palette. In another embodiment, the respective colors of the color palette correspond respectively to the set of musical notes. In one embodiment, the plurality of drawing instruments includes color pens that are calibrated to draw the respective colors of the color palette. In one scenario, an indication of the musical notes corresponding to the respective colors to which the color pens are calibrated is imprinted on the color pens. In another embodiment, a color-reading device includes an image sensor, a scanner, or a combination thereof for reading colors applied to a canvas. In a further embodiment, the plurality of drawing instruments is a plurality of virtual drawing instruments in a computer application, the canvas is a virtual canvas in the computer application, the color-reading device is a color-reading module of the computer application, and the color processing module is a module of the computer application. The computer application is executable on a mobile device.

In step 303, the image processing platform 103 may process using a color processing module the color data to generate a composition of the one or more musical notes from the color data based on a set of musical notes that correspond to the respective colors in the color data. In one example embodiment, the image processing platform 103 may process the color data to obtain one or more musical notes that correspond to the respective colors in the color data. Then, the image processing platform 103 may generate a sequence of the one or more musical notes in the composition based on an order of the respective colors applied to the canvas.

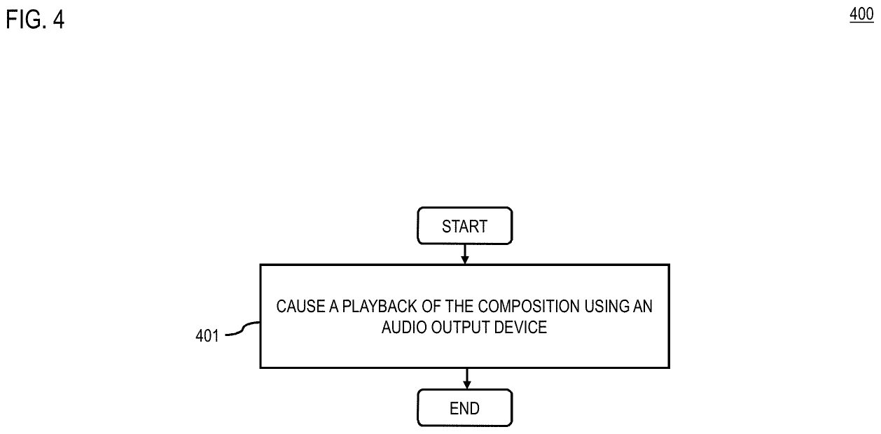

FIG. 4 is a flowchart of a process for causing a playback of the composition of the one or more musical notes, according to one example embodiment. In one embodiment, the image processing platform 103 performs the process 400 and is implemented in, for instance, a chip set including a processor and a memory as shown in FIG. 10.

In step 401, the image processing platform 103 may cause a playback of the composition using an audio output device. In one embodiment, the image processing platform 103 may generate an audio sequence based on the one or more color data and their respective sizes. In another embodiment, the color selected, their patterns and the consistency of painting may be adjusted to make harmonious audio output (e.g. tones). Then, the playback of the audio composition may be initiated. In one example embodiment, to output audio data, the input/output device 109 can be configured with an audio playback system.

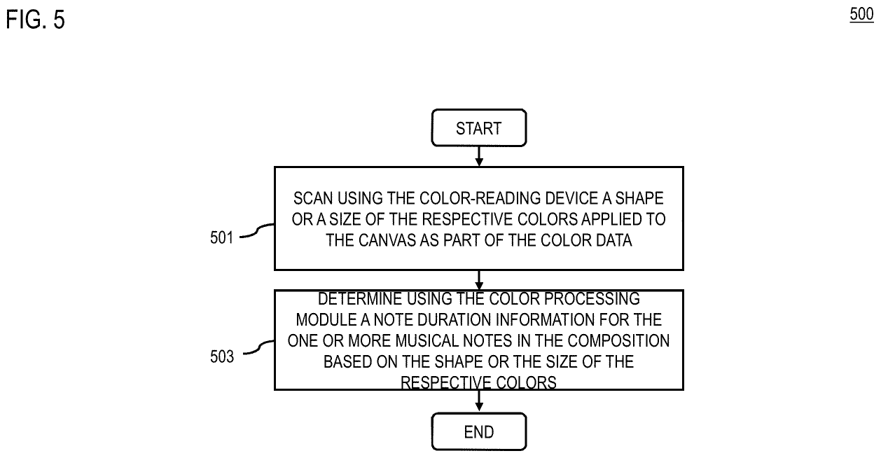

FIG. 5 is a flowchart of a process for determining note duration information for the one or more musical notes, according to one example embodiment. In one embodiment, the image processing platform 103 performs the process 500 and is implemented in, for instance, a chip set including a processor and a memory as shown in FIG. 10.

In step 501, the image processing platform 103 may scan using the color-reading device a shape or a size of the respective colors applied to the canvas as part of the color data. In one embodiment, the image processing platform 103 may determine respective durations of the one or more musical notes using the sizes of the one or more color data. In another embodiment, the one or more colors may be of a geometric shape, for example, the geometric shape includes a parallelogram.

In step 503, the image processing platform 103 may determine using the color processing module a note duration information for the one or more musical notes in the composition based on the shape or the size of the respective colors. In one embodiment, the composition is further generated based on the note duration information. In another embodiment, the note duration is identified by an equal proportion of color size being allocated to each musical note. In one embodiment, the color processing module is further configured to generate a representation of the composition in staff notation and to output the composition in the staff notation via an output device.

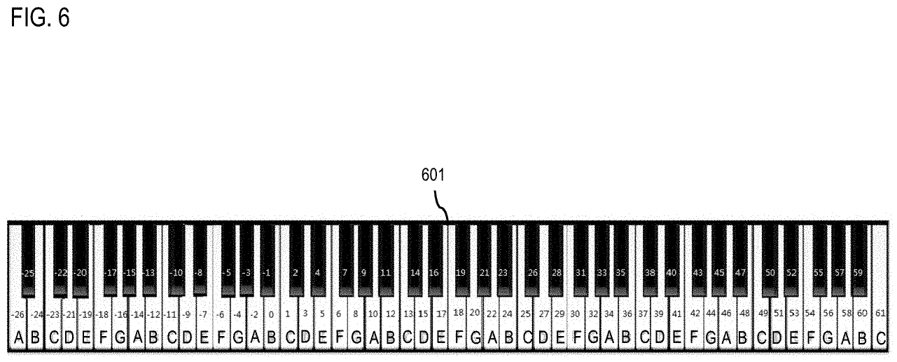

FIG. 6 is a diagram of a plano keyboard used in the various processes described herein. The fifty two white keys on the keyboard 601 are repeated every octave, giving seven basic tones. The adjacent octaves above and below share the tone names (or musical notes).

The zones can be divided into three treble, alto and bass areas. Each zone consists of seven basic tones and five semitones, comprising a total of 12 tones: C, C# (Db), D, D# (Eb), E, F, F# (Gb), G, G# (Ab), A, A# (Bb) and B. According to this sequence, an Arabic numeral can be allocated to each tone, creating a numerical sequence 1,2,3,4,5,6,7,8,9,10,11,12, in essence a music alphabet (see FIG. 6).

Therefore the three zones (bass, alto and treble) can each be encoded as: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36.

In one embodiment, the system 100 takes features from the color data and assigns musical notes (such as note numbers—see FIG. 6), for example, the numerical value associated with each notes. In another embodiment, the system 100 enables eliciting of musical notes from the color sets that encode note/tone and duration as described above by trying to match the color to the corresponding notes. This can be used to generate an audio expression that corresponds to the visual data (e.g., once the matches have been adjusted and filtered). In this way, a drawing or other visual representation can be used as a means for composing music.

In addition, the system 100 enables eliciting of music from the color sets or other visual representations that encode note/tone and duration as described above by trying to match the color bars (or other color visual elements in the visual representation or image) to the corresponding notes and durations. This can be used to generate an audio expression that corresponds to the visual data (e.g., once the matches have been adjusted and filtered). In this way, a painting or other visual representation can be used as a means for composing music.

In one embodiment, color cards form components of a continuum of colors in a collection. It is contemplated that although the various embodiments are discussed with mapping color to tones or notes, these tones or notes can also be mapped to patterns or designs. In addition, color, patterns, and designs can be combined in any combination. For example, a huge range of colors, patterns, and designs are available, and the system 100 can choose any desired color and acquire a completely standardized and digitalized marker for the color. In one embodiment, such specific markers are important in order to generate a single tone as perfectly matched to it as possible. With these sorts of cards (e.g., taken from a selected color space), the system 100 can rely on the serialization of the color values by following the “12 Equal Tone Temperament”. In one embodiment, sound databases can also be manufactured in this way, with the aid of the plano keyboard in FIG. 6 or other similar musical note correlation table, thereby enabling the system 100 to accurately match the visual values to audio ones.

In one embodiment, color cards are assigned to each color value in the sequence, which in turn matches the musical notes in a continuous sequence. A visual and intuitive form of notes can be expressed through drawings, via data conversion between color and musical notes.

In one embodiment, the system 100 may use data related to the shades, ranges, brightness, contrasts, or a combination thereof to determine progression of the melody, note values, sound volume and other factors. In one embodiment, the system 100 can generate the musical notes from a drawings in any medium, be it watercolor, gouache, acrylic, or oil paints.

For example, for a gradient of yellow fading to purple, the system 100 may match the midrange sequence of basic tones C, C# (Db), D, D# (Eb), E, F, F# (Gb), G, G, (Ab), A, A# (Bb), B, to a digitally encoded sequence of 13,14,15,16,17,18,19,20,21,22,23,24.

By way of example, the following Table 1 shows how timbre is encoded to correspond with certain color cards.

TABLE 1

| Tone/ | |
|---|---|
| Musical Note | Color |
| C 13 | Pantone Yellow U |
| C^{#}(D ^{b}) | Pantone Yellow 012 U |
| D | Pantone Orange 021 U |
| D# (E^{b}) | Pantone Bright Red U |
| E | Pantone Warm Red U |
| F | Pantone Red 032U |
| F^{#} (G^{b}) | Pantone Rubine Red U |
| G | Pantone Rhodamine Red U |
| G^{#}(A ^{b}) | Pantone Pink U |
| A | Pantone Purple U |
| A# (B^{b}) | Pantone Medium Purple U |
| B | Pantone Violet U |

In this example, the above sequence uses the yellow to purple gradient from the Pantone color space to match the tempered alto tones, and such a method can also be reversed. In selecting a musical notes based on the brightness of colors, the system 100 can increase or decrease the tones of the musical notes in proportion to this. As illustrated above from purple (dark) to yellow (light) in a gradient, the musical notes vary from C13 to B, and vice versa.

In one embodiment, the system 100 considers the size of one or more colors to determine a time value or duration of one or more musical notes. By way of example, common duration for notes include semibreve, minims, crotchets, quavers, semi-quaver, etc. In many cases, different notes have different time durations. For example, time duration in the score is used to express the relative duration between each bar. Time duration also determines how long a note lasts.

Therefore, in one embodiment, the system 100 may match the time duration of a musical note to the size of the color and make the duration of the musical note proportional to the size. In one embodiment, one or more colors may be filled in a unit cell. The unit cell may be used as the means of measurement for one or more colors applied on the canvas. The time value or note duration is identified by an equal proportion of unit cells being allocated to each note. For example, if the system 100 sets the time duration of a crotchet equal to the area of a unit cell. Then in one bar, a crotchet takes up one unit cell, a minim takes up two unit cells, a semibreve takes up four unit cell, a semi-quaver takes up half unit cell. In comparison, if the system 100 sets the time duration of a minim as the area of a unit cell, then a crotchet takes up half a unit cell, a minim takes up one unit cell, a semibreve takes up two unit cells, a quaver takes up one fourth of a unit cell. If the system 100 equals the duration of a semibreve to the area of a unit cell, a crochet takes up one fourth of a unit cell, minims takes up half of a unit cell, a semibreve takes up one unit cell, quavers takes up one eighth of a unit cell. And so forth, the area each specific note takes up is proportional to the duration of a note in accordance with the preset unit cell area. Therefore, the time duration of the musical notes corresponds to the color size in a unit cell.

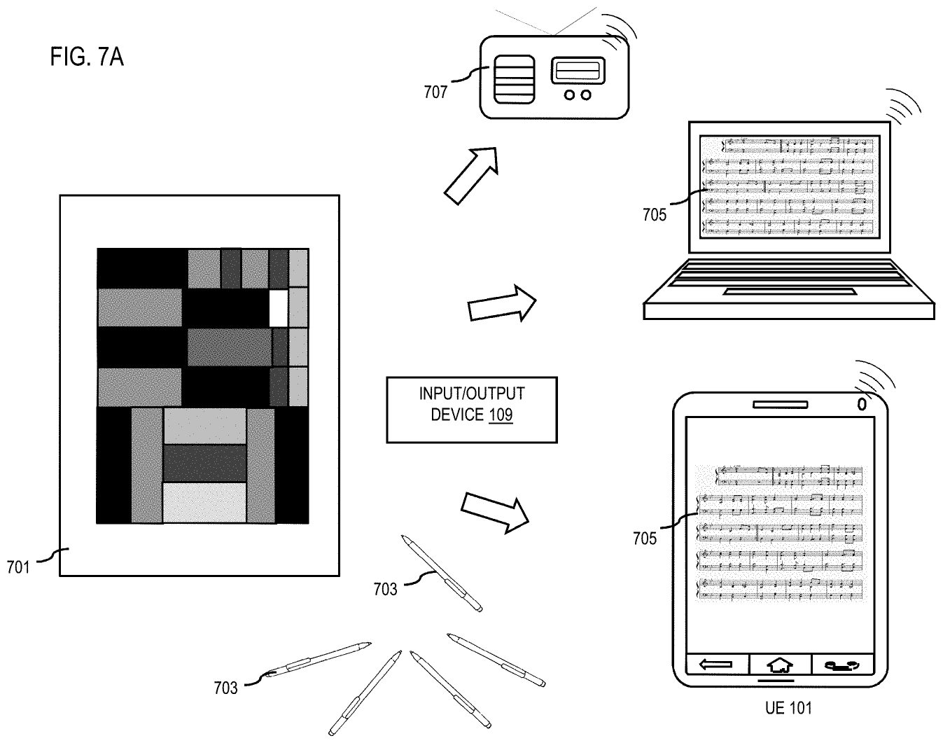

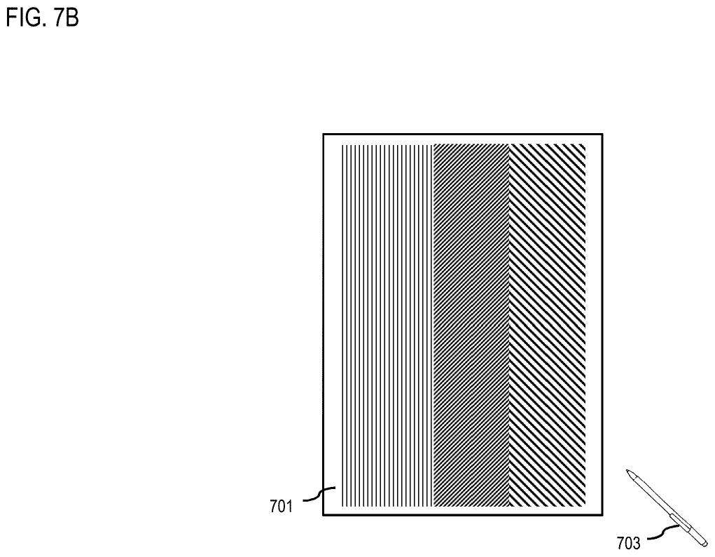

FIG. 7A is a diagram utilized in the processes of FIG. 3-5, according to one example embodiment. In one embodiment, a user draws on a canvas 701 with a drawing instrument 703 to create one or more musical notes. In one embodiment, the drawing instrument 703 includes a color calibrated pen configured to draw in respective colors of a color palette. These respective colors of the color palette correspond respectively to a set of musical notes. Then, the image processing platform 103 and/or the input/output device 109 may use a camera sensor 111 or a scanner to capture the drawing on the canvas 701. Subsequently, the image processing platform 103 and/or the input/output device 109 may process the drawings to determine one or more color data in the drawings. Next, the image processing platform 103 and/or the input/output device 109 may cause a mapping of the one or more color data with the one or more musical notes that corresponds to the respective colors in the color data. Subsequently, the image processing platform 103 and/or the input/output device 109 may generate a visual and/or aural representation 705 of the one or more musical notes, wherein the composition is presented in staff notation. In one embodiment, the visual and/or aural representation 705 of the staff notation may be generated in at least one UE 101 or in any other physical versions (e.g., paper, canvas, and/or other media). In one embodiment, these physical versions can be directly generated through appropriate output devices (e.g., printers or other automated means). In another embodiment, an audio representation 707 of the one or more musical notes may be generated from the color data.

FIG. 7B is a diagram that represents the colors applied on a canvas in a different format, according to one example embodiment. In one scenario, a user may use the drawing instrument 703 to draw colors in various shapes, patterns and sizes on the canvas 701. Subsequently, the image processing platform 103 may present a staff notation of the one or more musical notes that corresponds to the respective colors in various shapes, patterns and sizes on the canvas 701.

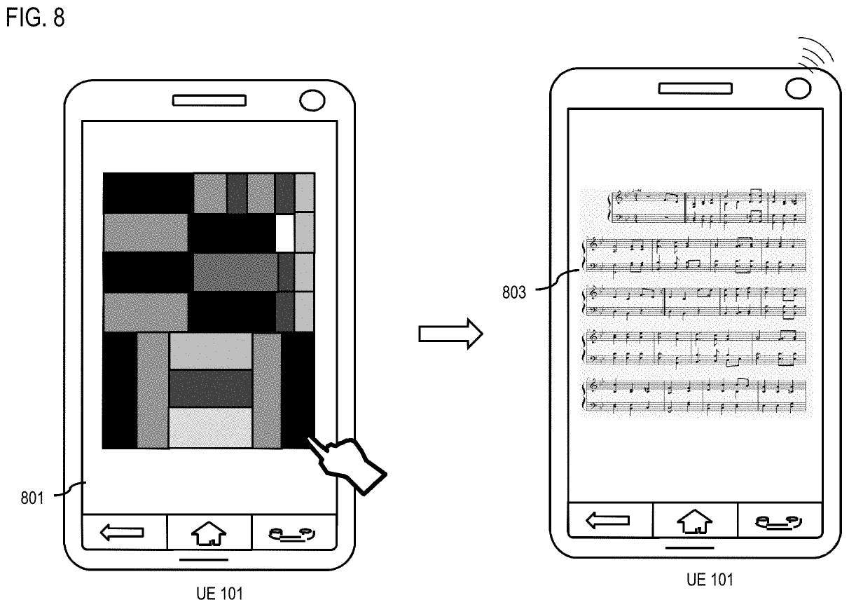

FIG. 8 is a user interface diagram utilized in the processes of FIG. 3-5, according to one example embodiment. In one embodiment, a user draws on a virtual canvas 801 in the computer application associated with the UE 101. The computer application associated with the UE 101 may present the user with respective colors of a color palette, wherein the color palette correspond respectively to a set of musical notes. Then, the user may select one or more colors from the color palette to create a drawing. Then, the image processing platform 103 may use a camera sensor 111 or a scanner to capture the drawing on the virtual canvas 801. Subsequently, the image processing platform 103 may process the drawings to determine the color data. Next, the image processing platform 103 may cause a mapping of the color data with the one or more musical notes that corresponds to the respective colors. Subsequently, the image processing platform 103 may generate a representation of the composition in staff notation (803). In one embodiment, the representation of the composition in staff notation (803) may be generated in at least one UE 101 or in any other physical versions. In another embodiment, the image processing platform 103 may generate an audio representation of the composition. In addition, although the examples of FIGS. 7A, 7B and 8 shows the colors in a drawing in a rectangular-shaped (parallelogram-shaped) cells, it should be noted that it can also be represented in different cell shapes, such as circles, trapezoids, triangles, diamonds, hexagons, crescents, and/or any other shapes, in order to enhance and enrich the conversion process.

The processes described herein for converting color data into one or more musical notes may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

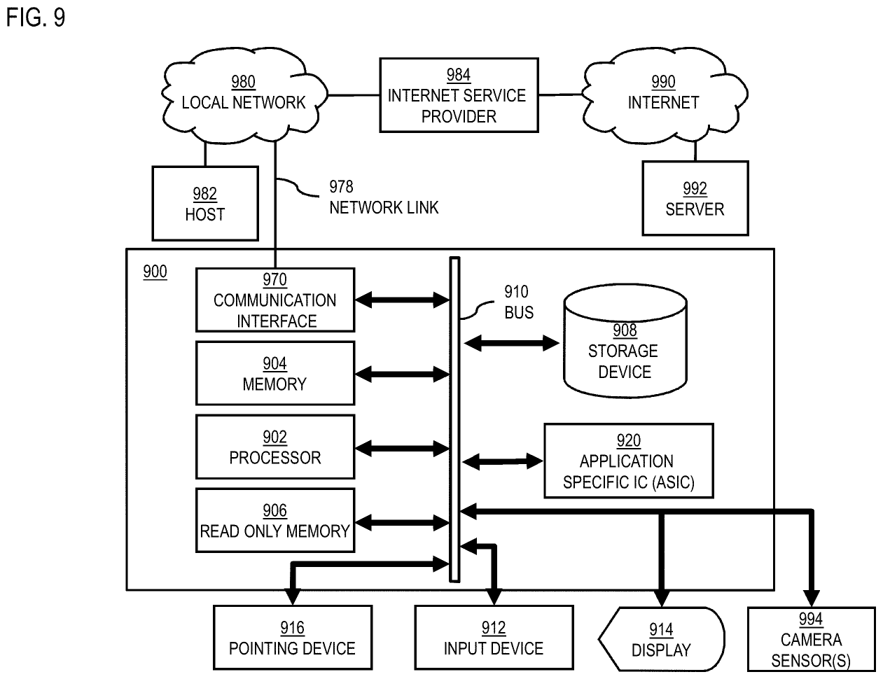

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to converting color data into one or more musical notes as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of converting color data into one or more musical notes.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to converting color data into one or more musical notes. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for converting color data into one or more musical notes. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for converting color data into one or more musical notes, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for converting color data into one or more musical notes to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to convert color data into one or more musical notes as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of converting color data into one or more musical notes.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to convert color data into one or more musical notes. The memory 1005 also stores the data associated with or generated by the execution of the inventive steps.

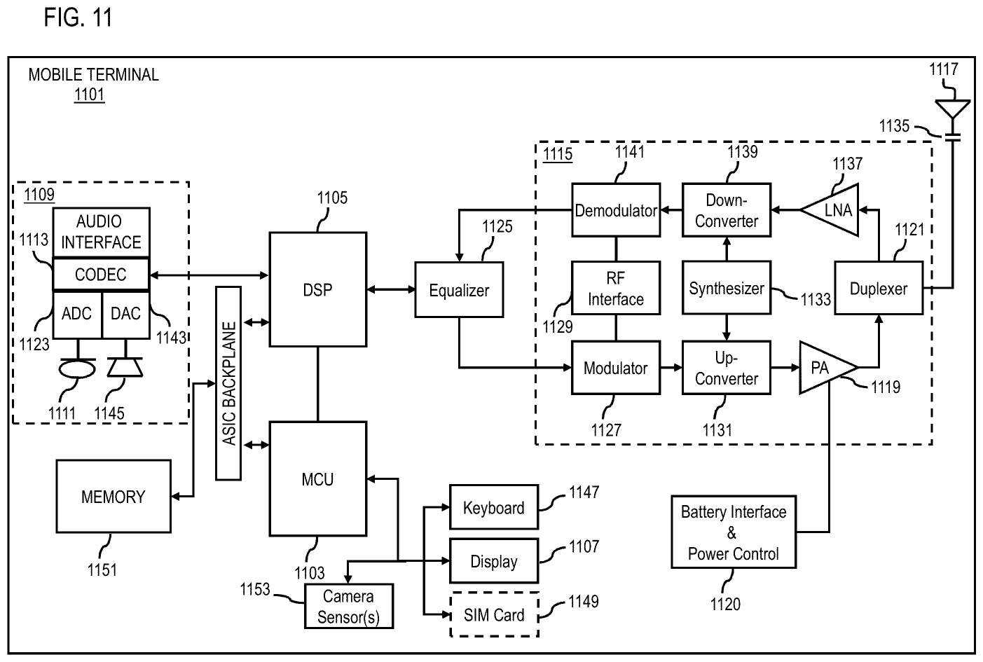

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of converting color data into one or more musical notes. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of converting color data into one or more musical notes. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to convert color data into one or more musical notes. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A system comprising:
a plurality of drawing instruments, wherein each of the plurality of drawing instruments is configured to draw in respective colors of a color palette, wherein the respective colors of the color palette correspond respectively to a set of musical notes;
a canvas configured for the plurality of drawing instruments to apply the respective colors of the color palette;
a color-reading device configured to read the respective colors applied to the canvas by the plurality of drawing instruments as color data; and
a color processing module configured to process the color data to generate a composition of the one or more musical notes from the color data based on the set of musical notes that correspond to the respective colors in the color data.

2. A system of claim 1, further comprising:
an audio output device configured to playback the composition.

3. A system of claim 1, further comprising:
the color-reading device further configured to scan a shape or a size of the respective colors applied to the canvas as part of the color data; and
the color processing module further configured to determine note duration information for the one or more musical notes in the composition based on the shape or the size of the respective colors,
wherein the composition is further generated based on the note duration information.

4. A system of claim 3, wherein the color processing module is further configured to generate a representation of the composition in staff notation and to output the composition in the staff notation via an output device.

5. A system of claim 1, wherein the plurality of drawing instruments includes color pens that are calibrated to draw the respective colors of the color palette.

6. A system of claim 5, wherein an indication of the musical notes corresponding to the respective colors to which the color pens are calibrated is imprinted on the color pens.

7. A system of claim 1, wherein the color-reading device includes an image sensor, a scanner, or a combination thereof.

8. A system of claim 1, wherein a sequence of the one or more musical notes in the composition is based on an order of the respective colors applied to the canvas.

9. A system of claim 1, wherein the plurality of drawing instruments is a plurality of virtual drawing instruments in a computer application, wherein the canvas is a virtual canvas in the computer application, wherein the color-reading device is a color-reading module of the computer application, and wherein the color processing module is a module of the computer application.

10. A system of claim 9, wherein the computer application is executable on a mobile device.

11. A computer implemented method for converting color data to one or more musical notes, the method comprising:
reading, using a color-reading device, respective colors applied to a canvas by a plurality of drawing instruments as color data, wherein each of the plurality of drawing instruments is configured to draw in respective colors of a color palette, and wherein the respective colors of the color palette correspond respectively to a set of musical notes; and
processing, using a color processing module, the color data to generate a composition of the one or more musical notes from the color data based on a set of musical notes that correspond to the respective colors in the color data.

12. A method of claim 11, further comprising:
causing a playback of the composition using an audio output device.

13. A method of claim 11, further comprising:
scanning, using the color-reading device, a shape or a size of the respective colors applied to the canvas as part of the color data; and
determining, using the color processing module, a note duration information for the one or more musical notes in the composition based on the shape or the size of the respective colors,
wherein the composition is further generated based on the note duration information.

14. A method of claim 13, wherein the color processing module is further configured to generate a representation of the composition in staff notation and to output the composition in the staff notation via an output device.

15. A method of claim 11, wherein the plurality of drawing instruments includes color pens that are calibrated to draw the respective colors of the color palette.

16-20. (canceled)

21. An apparatus comprising:
at least one processor; and
at least one memory including computer program code for one or more programs,
the at least one memory and the computer program code configured to, with the at least one processor, cause the apparatus to perform at least the following,
read, using a color-reading device, respective colors applied to a canvas by a plurality of drawing instruments as color data, wherein each of the plurality of drawing instruments is configured to draw in respective colors of a color palette, and wherein the respective colors of the color palette correspond respectively to a set of musical notes; and
process, using a color processing module, the color data to generate a composition of the one or more musical notes from the color data based on a set of musical notes that correspond to the respective colors in the color data.

22. An apparatus of claim 21, further comprising:
cause a playback of the composition using an audio output device.

23. An apparatus of claim 21, further comprising:
scan, using the color-reading device, a shape or a size of the respective colors applied to the canvas as part of the color data; and
determine, using the color processing module, a note duration information for the one or more musical notes in the composition based on the shape or the size of the respective colors,
wherein the composition is further generated based on the note duration information.

24. An apparatus of claim 23, wherein the color processing module is further configured to generate a representation of the composition in staff notation and to output the composition in the staff notation via an output device.

25. An apparatus of claim 21, wherein the plurality of drawing instruments includes color pens that are calibrated to draw the respective colors of the color palette.

26-35. (canceled)
